(19) United States
(12) Patent Application Publication
(10) Pub. No.: US 2007/0231581 A1
(43) Pub. Date: Oct. 4, 2007

(54) Epoxy with low coefficient of thermal expansion

(76) Inventors: Pui-Yan Lin, Hockessin, DE (US); Govindasamy Paramasivam Rajendran, (US); George Elias Zahr, Glen Mills, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/732,319

(22) Filed: Apr. 3, 2007

Related U.S. Application Data
(60) Provisional application No. 60/788,651, filed on Apr. 3, 2006.

(51) Int. Cl. B32B 27/38; B32B 15/092; C08L 63/00; B32B 27/18

(52) U.S. Cl. 428/413; 428/418; 525/533

(57) ABSTRACT

Epoxy compositions that exhibit low viscosity in the uncured state and low coefficient of thermal expansion in the cured state are provided. The compositions are well-suited for use as dielectrics in electronics applications such as in multi-layer printed circuit boards, integrated circuit (IC) chip substrates, also known as IC chip carriers, and IC chip package interposers.

### FIELD OF THE INVENTION

The present invention is directed to epoxy compositions that exhibit low viscosity in the uncured state and low coefficient of thermal expansion in the cured state. The compositions are well-suited for use as dielectrics in electronics applications such as in multi-layer printed circuit boards, integrated circuit (IC) chip substrates, and IC chip package interposers.

### BACKGROUND

So called “epoxy resins” are polymeric materials characterized by the presence of more than one epoxide ring per molecule on average. Epoxies have a tremendous range of applications in modern day society. These applications include coatings on metal cans, automotive primers, printed circuit boards, semiconductor encapsulants, adhesives, and aerospace composites. Epoxies are, in general, thermoset polymers which, in the presence of a curing agent, or cross-linking agent, undergo extensive cross-linking to form a three dimensional polymer network. Most cured epoxy resins form relatively dimensionally stable amorphous networks with excellent mechanical strength and toughness; outstanding chemical, moisture, and corrosion, resistance; and variously good thermal, adhesive, and electrical properties. The highly useful combination of properties, along with versatility in formulation and low cost, have led to the widespread use of epoxies in a plethora of adhesive, structural, and coatings applications.

Great demands are placed upon the epoxy employed as dielectrics for the built up layers in the multilayer printed circuit board application. The dielectric layer is desirably matched in coefficient of thermal expansion (CTE) to that of the copper (ca. 17 ppm/° C.) and to that the silicon chip (3-4 ppm/° C.), to avoid stress-induced delamination and fracture during the manufacturing processes and in thermal excursions during use. Recently, CTE in the out-of-plane direction has taken on increasing importance due to decreasing feature sizes. The uncured composition must be of sufficiently low viscosity at the lamination temperature so that it will fill all the space between conductors; and the cured epoxy must retain sufficient toughness (usually measured as elongation to break or fracture toughness) to endure repeated thermal cycling and possible mechanical impacts during use (as in, e.g., a cellular phone). It is also desirable that a simple chemical etching of the surface to provide the desired degree of roughness—ca. 0.1-1 micrometer—for copper lamination which will maintain an adhesive strength of at least ca. 6 N/cm.

Most common dielectrics layers are epoxy resins which exhibit CTE values of 80 ppm/° C. and higher. One approach to achieving reduction of CTE has been to employ heavy loadings of inorganic fillers on the order of 1-20 micrometers in average particle size. While reducing CTE, high loadings of inorganic fillers have resulted in increased brittleness, increased viscosity, poor adhesion strength, and degraded dielectric properties.

There is a clear need in the art for improved property trade-offs in epoxies employed in building up multilayer printed circuits.

US 2005/0008868 A1 assigned to Ajinomoto describes highly filled epoxies to arrive at low CTE. A 43 wt % filler was used to achieve a CTE of 44 ppm/° C. (Example 2).

Farren et al., Polymer (2001) 42, 1507-1514 discloses amine-cured liquid crystalline epoxies with CTE of ˜45 ppm/° C.

GB845057(A) discloses curing of epoxies with less than a 50% weight ratio of pyromellitic dianhydride (PMDA).

U.S. Pat. No. 2,995,688(A) discloses curing epoxies with ca. 25% by weight anhydride.

R. B. Field et al. Industrial and Engineering Chemistry, v. 49 (3), 1957, pp. 369-373, disclose the use of PMDA in combination with a monoanhydride for curing epoxy. The effects of varying PMDA concentration in the mixture, and the effects of varying-anhydride to epoxide molar ratio are reported. It is stated that at high levels of PMDA, brittleness results.

Wada et al., U.S. Pat. No. 5,145,889, discloses anhydride curing of epoxies, with weight ratios of 70-120 parts of anhydride to 100 parts of epoxy.

### SUMMARY OF THE INVENTION

The present invention provides a composition comprising 45 to 65 parts by weight of an aromatic or cycloaliphatic dianhydride, and 55 to 35 parts by weight of an epoxy, or the cross-linked reaction product thereof, wherein the molar ratio of anhydride to epoxide units is in the range of 0.4 to 3.0.

The present invention further provides a film or sheet comprising an composition comprising 45 to 65 parts by weight of an aromatic or cycloaliphatic dianhydride, and 55 to 35 parts by weight of an epoxy, or the cross-linked reaction product thereof, wherein the molar ratio of anhydride to epoxy is in the range of 0.4 to 3.0.

The present invention further provides a laminated structure comprising a film or layer having a surface, said film or layer comprising the cross-linked reaction product of an epoxy and an aromatic dianhydride, comprising 45 to 65 parts by weight of cross-linked aromatic or cycloaliphatic dianhydride residues, and 55 to 35 parts by weight of epoxy residue cross-links, and a plurality of discrete conductive pathways disposed upon said surface.

### BRIEF DESCRIPTION OF THE DRAWINGS

FIG. 1 depicts schematically an electronic chip package comprising a multilayer built up epoxy material.

FIG. 2 depicts one method for forming a multilayer printed circuit.

### DETAILED DESCRIPTION

In the processes disclosed herein, an anhydride moiety reacts with two epoxy moieties to form cross-links between epoxy-containing polymeric chains. It is well understood in the art that the anhydride-epoxy reaction takes place via intermediate steps involving the acid forms of the anhydrides formed by reaction with adventitious water or hydroxyl groups in the epoxy molecule. “Curing” is the term of art employed to refer to that reaction. Once the curing or, as it is also known, cross-linking, reaction has taken place the epoxy groups have reacted to form ester linkages and ether linkages with the anhydride groups. Thus, after reaction are the reaction product of the curing reaction which comprises residues of the epoxy chemically linked to residues of the anhydride. The residue comprises the cured species of the respective uncured, unlinked species of which the composition is formulated.

The term “epoxy” represents a polymeric, generally an oligomeric, chemical comprising epoxide groups. A cross-linking agent suitable for use in the processes disclosed herein is a difunctional molecule reactive with epoxide groups. The cross-linked reaction product thereof is the reaction product formed when the cross-linking agent reacts with the epoxide or other group in the epoxy molecule. The term “epoxy” is conventionally used to refer to an uncured resin that contains epoxide groups. With such usage, once cured the epoxy resin is no longer an epoxy. However, reference to epoxy herein in the context of the cured material shall be understood to refer to the cured material. The term “cured epoxy” shall be understood to mean the reaction product of an epoxy as defined herein and a curing agent as defined herein.

The term “cured” refers to the composition which has undergone substantial cross-linking, the word “substantial” indicating an amount of cross-linking of 75% to 100% of the available cure sites in the epoxy. Preferably about 90% of the available cure sites are cross-linked in the fully cured composition. The term “uncured” refers to the composition when it has undergone little cross-linking. The terms “cured” and “uncured” shall be understood to be functional terms. An uncured composition is characterized by solubility in organic solvents and the ability to undergo plastic flow. A cured composition is characterized by insolubility in organic solvents and the absence of plastic flow under ambient conditions. In the practice of the present invention, some of the available cure sites in the uncured composition will be cross-linked and some of the available cure sites in the cured composition will remain uncross-linked. In neither case, however, are the distinguishing properties of the respective compositions significantly affected.

As discussed further infra, there is also a partially cured state known as the “B-stage” material. The B-stage material may contain up to 10% by weight of solvent, and exhibits properties intermediate between the substantially cured and the uncured state.

The terms “film” and “sheet” refer to planar shaped articles having a large length and width relative to thickness. Films and sheets differ only in thickness. Sheets are typically defined in the art as characterized by a thickness of 250 micrometers or greater, while films are defined in the art as characterized by a thickness less than 250 micrometers. As used herein, films or sheets may be free-standing, or may be disposed upon a surface. As used herein, the term “film” encompasses coatings disposed upon a surface.

The term “discrete conductive pathway” as used herein refers to a conductive pathway which leads uniquely from one point to another on the plane of a film or sheet, or through the plane from one side to the other, with no electrically conductive contact between two discrete conductive pathways.

A photoresist is a material, generally an organic material, which either polymerizes or de-polymerizes upon exposure to light. Imagewise exposure means that the photoresist surface is exposed to light which forms an image on the photoresist so that when the photoresist is developed and the surface etched, the image will appear in the form of a plurality of discreet conductive pathways upon the surface of the film or sheet.

It is well-known in the art to employ organic acid anhydrides as curing agents for epoxies. Both monoanhydrides and dianhydrides are used but monoanhydrides are generally preferred in commercial applications. Aromatic dianhydrides may be more problematical to work with because of limited solubility in processing. In addition the art teaches that quantities of pyromellitic dianhydride (PMDA) approaching 50% by weight of PMDA can result in brittle epoxies.

In one embodiment, the present invention provides an uncured composition comprising 45 to 65, preferably 45 to 55, parts by weight of an aromatic or cycloaliphatic dianhydride, and 55 to 35, preferably 55 to 45, parts by weight of an epoxy resin, and wherein the molar ratio of anhydride to epoxy is in the range of 0.4 to 3.0, preferably 0.4-2.2

In a further embodiment of the present invention, it has been found that films having a coefficient of thermal expansion less than 60 ppm/° C. (measured below the Tg of the resin) can be prepared by cross-linking an uncured film of a highly flowable composition comprising 45 to 65, preferably 45 to 55, parts by weight of PMDA and 55 to 35, preferably 55 to 45, parts by weight of an epoxy, wherein the molar ratio of anhydride to epoxide is in the range of 0.4 to 1.0. Suitable epoxies are aromatic epoxies comprising at least two epoxide groups per average polymer chain. Suitable aromatic epoxies include but are not limited to the glyidyl ether of biphenol-A, bisphenol F, epoxy novolacs (epoxidized phenol formaldehyde), naphthalene epoxy, the trigylcidyl adduct of p-aminophenol, the tetraglycidyl amine of methylenedianiline, and triglycidyl isocyanurates. Preferred epoxies include epoxy novolacs, the trigylcidyl adduct of p-aminophenol, the tetraglycidyl amine of methylenedianiline, or triglycidyl isocyanurates. Most preferably the epoxy is selected from the cresol-novolacs.

Epoxies can be derivatized in any manner described in the art. In particular they can be halogenated, especially with bromine to achieve flame retardancy, or with fluorine.

Suitable anhydrides for use as curing agents are aromatic or cycloaliphatic anhydrides. Suitable anhydrides include but are not limited to aromatic tetracarboxylic acid dianhydrides such as pyromellitic dianhydride, biphenyltetracarboxylic acid dianhydride, benzophenonetetracarboxylic acid dianhydride, oxydiphthalic acid dianhydride, 4,4′-(hexafluoroisopropylidene) diphthalic acid dianhydride, naphthalene tetracarboxylic acid dianhydrides, thiophene tetracarboxylic acid dianhydrides, 3,4,9,10-perylene tetracarboxylic acid dianhydrides pyrazine tetracarboxylic acid dianhydrides, 3,4,7,8-anthraquinone tetracarboxylic acid dianhydrides and cycloaliphatic tetracarboxylic acid dianhydrides such as cyclobutanetetracarboxylic acid dianhydride and cyclopentanetetracarboxylic acid dianhydride. Most preferred is pyromellitic acid dianhydride.

A tetracarboxylic acid dianhydride suitable for use in the processes disclosed herein can be in the form of pure anhydride or the tetracarboxylic acids and tetracarboxylic acid monoanhydrides. Also suitable are aromatic monoanhydrides, including carboxylic acid monoanhydrides such as trimellitic anhydride.

The tetracarboxylic acids and tetracarboxylic acid monoanhydrides are obtained by reacting the tetracarboxylic acid dianhydrides with water to cause ring opening. They may be derived from either aromatic tetracarboxylic acid dianhydrides or cycloaliphatic tetracarboxylic acid dianhydrides. The tetracarboxylic acid dianhydrides may contain, as impurities, partly ring-opened monoanhydrides or tetracarboxylic acids.

Combinations of epoxies and combinations of aromatic or cycloaliphatic dianhydrides can also be used.

While not a requirement, it is generally preferred to employ a cross-linking catalyst.

Adjuvants that are commonly employed in the art can be employed in the compositions disclosed herein. These include toughening agents, solvents fillers, either organic or inorganic. Excessive amounts of toughening agents will detract from the low CTE property of the composition. 20 weight parts or less of toughening agents per 100 parts of the composition is preferred.

In one embodiment, the composition can be prepared by combining 45 to 65, preferably 45 to 55 parts by weight of a suitable aromatic or cycloaliphatic anhydride dissolved in a suitable solvent with 55 to 35, preferably 55 to 45 parts by weight of a suitable epoxy dissolved in the same solvent, or a solvent miscible therewith, with the proviso that the molar ratio of anhydride groups to epoxy groups should be in the range of 0.4-3.0, preferably 0.4-2.2. Preferred co-solvents should have boiling points above the reaction temperature of the applicable dianhydride-epoxy reaction. Most preferably, a co-solvent has about the same boiling point as the other co-solvent so as not to volatilize prematurely during cure)] Preferably the composition comprises 45-55 parts by weight of dianhydride. Preferably the dianhydride is PMDA. Typical concentrations in solution are 1 to 65% by weight solids. High solids content can render the solution very viscous.

Suitable solvents include but are not limited to acetone, methyl ethyl ketone (MEK), cyclohexanone, pentanone, dioxolane, tetrahydrofuran, glycol ethers, propylene glycol methyl ether acetate (PMA), N-methylpyrrolidone, N,N-dimethylacetamide, N,N-dimethylformamide (DMF), dimethyl sulfoxide, N,N-diethylacetamide, N,N-diethylformamide, N,N-dimethylmethoxyacetamide. Preferred solvents are MEK, PMA, and DMF. Mixtures of solvents are also suitable.

If the molar ratio of anhydride to epoxide groups is below 0.4 there may be inadequate cross-linking. If the ratio exceeds 3.0 there is excessive anhydride residue which is hygroscopic. Water absorption is undesirable in electronic circuits. When the weight ratio of dianhydride to epoxy is below 45/55 the surprising decrease in coefficient of thermal expansion to less than 60 ppm/° C., measured at below the glass transition temperature, is not observed. When the weight ratio of dianhydride to epoxy is above 65/35 integrity of the resulting film decreases.

The viscosity of the uncured composition so prepared can be adjusted simply by either adding solvent to decrease the viscosity, or by evaporating solvent to increase viscosity. The uncured composition can be poured into a mold, followed by curing, to form a shaped article of any desired shape. One such process known in the art is reaction injection molding. It is anticipated that the composition will find greater utilization in forming films or sheets, or coatings. Following the preparation of the composition, the viscosity of the solution is adjusted as appropriate to the requirements of the particular process. Films, sheets, or coatings are prepared by any convenient process known in the art. Such processes include solution casting, slot die coating, gravure coating, roll coating, spray-coating, spin-coating, or painting. A preferred use in forming a layer in a multi-layer printed circuit is slot-die coating wherein the solution is driven through a narrow rectangular slot and coated as a film on a substrate such as a polyethylene terephthalate. Also suitable for film forming is solution casting using a Meyer rod or doctor blade for metering and draw down of the casting solution deposited onto a substrate. Solution cast films are generally ca. 35 to 100 micrometers in thickness when a substantial amount of the solvent has been removed.

In one embodiment, the uncured composition is solution cast onto a release surface, preferably a polyethylene terephthalate film such as Mylar® available from DuPont Teijin Films. The cast film then is subject to solvent removal, usually accompanied by low temperature heating, to leave behind a high viscosity uncured or very lightly cured composition (B-stage) then disposed onto the surface of the previously prepared layer comprising conductive pathways, and the combination so formed is subject to heat and pressure to cause it to flow into the interstices among the conductive pathways, followed by removal of the polyethylene terephthalate film backing and completion of curing.

Curing of the uncured composition can proceed via heating to a temperature of about 65° C. in the absence of catalyst. Addition of catalyst accelerates the cure. The absence of catalysts allows more complete removal of volatiles for thicker samples before the resin solidifies.

Suitable catalysts are described, for example, in Encyclopedia of Polymer Science and Technology, “Epoxy Resins” (John Wiley & Sons 2004), International Encyclopedia of Composites, “Epoxy Resins” (VCH Publishers 1990). Particularly suitable catalysts are tertiary amines and imidazoles. Preferred imidazole catalysts are N-methylimidazole, 2-methylimidazole, 2-ethyl-4-methylimidazole, 2-phenylimidazole. Suitable concentration of catalyst is in the range 0.01-5 phr (parts per hundred weight resin) depending on the rate of cure desired.

An inorganic filler may be included in the uncured and cured compositions. A beneficial effect of some fillers is to further decrease the coefficient of thermal expansion, provided such fillers themselves possess relatively low CTEs. Other fillers can impart other properties such as light reflectance, color, fluorescence, etc. Suitable filler loadings are 10 to 75 parts by weight, preferably 20 to 65 parts by weight, to 100 parts by weight of the epoxy plus dianhydride. Suitable inorganic fillers include but are not limited to talc, fumed silica, quartz powder, alumina, colloidal silica, glass flakes, glass balloons, glass powder; clay such as montmorillonite, hectorite, mica, sepiolite, vermiculite; calcium carbonate, titanium dioxide, iron oxide, barium sulfate, aluminum hydroxide, magnesium hydroxide, magnesium carbonate, magnesium oxide, boron nitride, aluminum borate, barium titanate, strontium titanate, calcium titanate, magnesium titanate, bismuth titanate, barium zirconate, calcium zirconate and the like. Silica is especially preferable.

An inorganic filler having an average particle size of 5 micrometer (μm) or less is preferable. When the average particle size exceeds 5 μm, it is sometimes difficult to form a fine pattern of uniform dimensions when forming a circuit pattern on the conductor layer. Filler size of less than 1 micrometer is more preferred. Silane-treated fillers are preferred. Silane surface treatments are suitable for fillers compatible with such treatment chemistry, for examples, silica. Cationic treatments are generally preferred for swellable clays such as montmorillonite with cationic exchangeable sites.

A variety of additives can be included in the cured and uncured compositions. These include stabilizers, pigments, flow modifiers, UV light blockers, fluorescent additives, tougheners, plasticizers, and flame retardants such as are known in the art.

Suitable tougheners are low molecular weight elastomers or thermoplastic polymers and contain functional groups for reaction with epoxy resin, monofunctional long chain epoxy resin, rubber-modified epoxy resin. Suitable tougheners include but are not limited to polybutadienes, polyacrylics, phenoxy resin, poly(phenylene ether), poly(phenylene sulfide) and poly(ether sulfone).

The uncured composition when cured forms a cured composition that exhibits a highly beneficial combination of low coefficient of thermal expansion, high toughness, and high adhesion to copper.

In a preferred method for preparing a film or sheet the uncured composition is first dissolved in a solvent to form a coating solution, and the coating solution so prepared is then solution cast onto a substrate preferably through a slot-die. Alternatively, a draw-down rod or doctor blade may be used. Suitable substrates include: polyesters such as polyethylene terephthalate (PET) and polyethylene naphthalate; polycarbonate; polyimide; release paper; metallic foils such as copper foil and aluminum foil. The support film may optionally be subjected to a mud treatment, a corona treatment, or a silicone or other release treatment. The cast uncured film or sheet is then devolatilized to increase the viscosity of the cast film.

The uncured composition can be employed as a so-called “pre-preg” with a woven or non-woven fabric comprising carbon, glass, quartz, aramid, boron fibers, or ceramic whiskers or mixtures thereof, for the purpose of preparing a reinforced composite material, such as a core layer for printed circuit boards. A prepreg can be produced by dipping the woven or non-woven fabric into the epoxy resin composition of the invention by a hot melt method or a solvent method, and semi-curing or “B-staging” it through heating.

Suitable solvents include but are not limited to acetone, methyl ethyl ketone (MEK), cyclohexanone, pentanone, dioxolane, tetrahydrofuran, glycol ethers, propylene glycol methyl ether acetate (PMA), N-methylpyrrolidone, N,N-dimethylacetamide, N,N-dimethylformamide (DMF), dimethyl sulfoxide, N,N-diethylacetamide, N,N-diethylformamide, N,N-dimethyl methoxyacetamide. Preferred solvents are MEK, PMA, and DMF. Mixtures of solvents are also suitable. While the conditions of solution concentration, coating thickness, drying time and other conditions will depend upon the particular compositions employed and the application intended, it has been found in the practice of the invention that a coating composition containing from 15 to 60% by weight of the organic solvent can be dried at from 50-70° C. for 30 min to an hour. Conditions can be adjusted so that the amount of the solvent remaining in the cured composition is 15% by weight or less, preferably 5% by weight or less, based on the total weight of the composition. Excessive curing will result in poor gap filling ability and difficulty in removing the PET backing prior to subsequent curing.

The resulting composition which is viscous and either uncured or slightly cured is referred to in the art as the “B-stage.” The combination of the substrate and the B-stage coating thereon shall be referred to herein as the “B-stage laminate.”

In one embodiment, drying of the B-stage composition is continued, followed by or accompanied by curing to prepare a fully or substantially cured film or sheet on the substrate. In one embodiment, a film or sheet is removed from the substrate to form a free-standing film or sheet. In a second embodiment, the cured layer remains on the substrate forming a laminate Depending upon the materials and conditions employed, the film or sheet thereby prepared may be thermoformable. As a general rule, a thinner film or sheet is more efficiently devolatilized than a thicker one. Furthermore, the more rapid the cure for a given thickness, the less efficient the devolatilization.

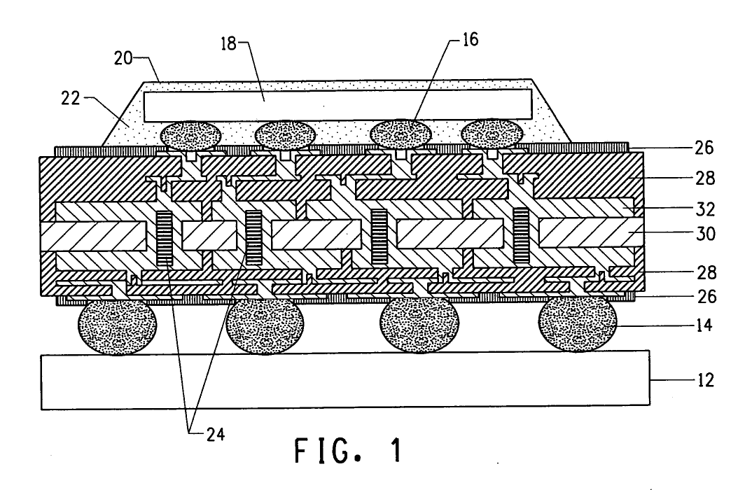

An electronic chip mounted on a multi-layer printed circuit board of the type in common commercial use, is depicted schematically in FIG. 1. An integrated circuit chip, 18, is mounted via contacts, typically solder balls, 16, onto the multi-layer printed circuit (typically called integrated circuit chip substrate), which in turn is mounted on a larger printed circuit board, e.g., a computer motherboard, 12, via contacts, 14. The integrated circuit chip, 18, is encapsulated, typically with a cured epoxy resin, 22. The multi-layer integrated circuit chip substrate is made up of a core, 30, generally a multi-layer rigid fiber-reinforced dieletric ca. 150 to 800 micrometers in total thickness. The core, 30, is flanked by one or more layers on either or both sides by additional dielectric layers, typically of cured epoxy resins, 28, each layer typically ca. 35 to 65 micrometers in thickness. Each layer carries one or more, typically numerous, within-layer conductive pathways, 32, generally copper, seen in cross-section, typically 8-35 micrometers thick, as well as layer to layer conductive pathways or “vias,”, also seen in cross-section. The space between the conducting pathways in any layer is completely filled by the dielectric, 28.

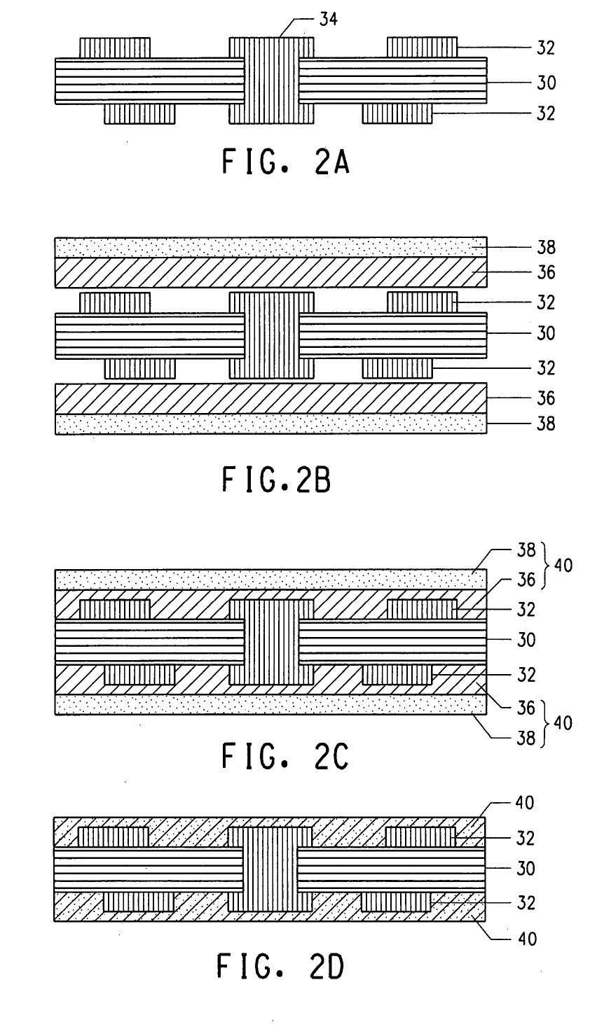

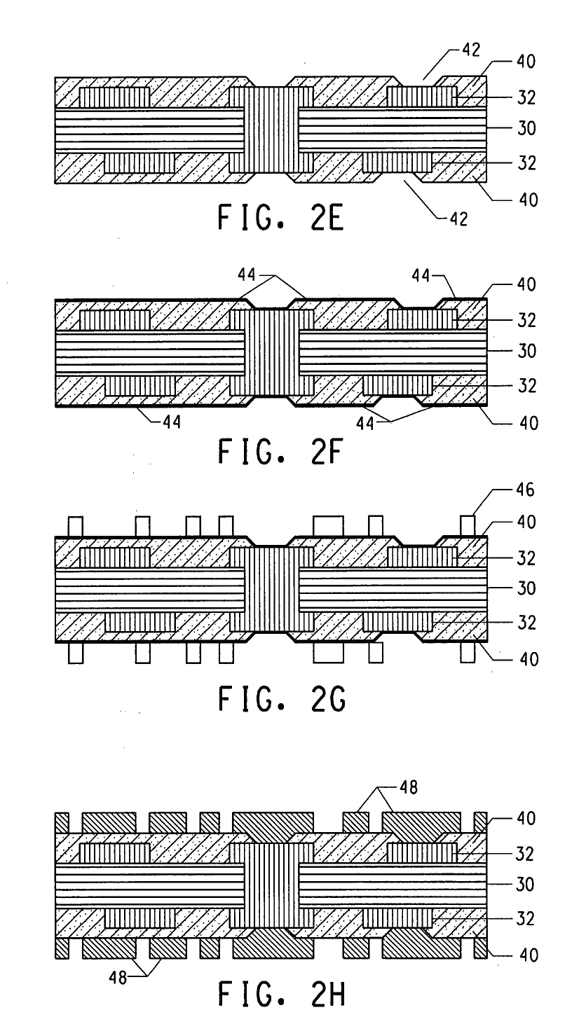

FIG. 2 depicts schematically one manner in which multi-layer printed circuits are formed. In a first step, not shown, copper is uniformly deposited over the surface of a core, 30, typically one or more layers of epoxy-fiberglass or bismaleimide/triazine-epoxy/fiberglass composite sheet totaling 150 to 800 micrometers in thickness, provided with pre-drilled holes. Using well-known procedures, not shown, the copper is then coated with a photoresist, image-wise illuminated, developed, undesired copper regions etched away, and residual photoresist removed. Each side of the core-layer may be independently imaged. The result, FIG. 2A, is a two sided printed circuit board having both interlayer, 34, and within-layer, 32, conductor pathways 8 to 15 micrometers thick. The space between the conductive pathways contains air or some other gaseous atmosphere at this stage. A second layer is then formed by applying a further dielectric layer. As shown in FIG. 2B, a backing sheet, typically of poly(ethylene terephthalate) (PET), 38, is coated with an uncured dielectric layer, 36, which is contacted to the printed circuit board of FIG. 2A. The uncured epoxy layer is laminated to the core surface by pressure and heat, causing it to flow into all the spaces on the core layer printed circuit, preferably filling them completely, as depicted in FIG. 2C. The backing sheet is removed, the laminated structure is subject to curing at elevated temperature, forming a new solid dielectric surface, 40, as depicted in FIG. 2D. New vias, 42, are then laser-cut into the solid dielectric surface, as depicted in FIG. 2E. The surface then undergoes a chemical desmear process to remove processing debris and to prepare the dielectric surface for electroless copper plating. A thin layer of copper, 44, is then applied using electroless method. A photoresist is applied and the photoresist is imaged, FIG. 2G, and developed to form a pattern, 46. Then a layer of copper ca. 8 to 15 micrometer thick is electroplated onto the surface thereby produced, and the photoresist stripped off, and undesired electroless copper chemically etched off, FIG. 2G, leaving a new layer of copper conductive pathways, 48. Additional layers may be applied in a similar manner.

In one embodiment, referring to FIG. 2, in FIG. 2B, the B-stage layer 10-150 μm in thickness, 36, is laminated to a release sheet, 38, preferably a PET sheet 150-200 μm in thickness, such as Mylar® from DuPont Teijin films, and positioned so that the B-stage layer contacts a reinforced core layer, 30, having electrically conductive pathways, both in-plane, 32, and through-plane, 34, disposed thereupon, the electrically conductive pathways being separated by open spaces. In FIG. 2C, the B-stage laminate so disposed is subject to heat and pressure, typically 70-140° C. and 0.1-1.1 MPa, preferably using vacuum lamination equipment at a pressure preferably not exceeding 20 torr, thereby causing the B-stage composition to flow into the open spaces and filling them. In FIG. 2D, the release sheet of the B-stage laminate is removed, and the newly formed laminated printed circuit board is subject to heating to cure the B-stage composition. Thermal curing is effected in the temperature range of 150° C. to 220° C., preferably 160 to 200° C. for a period of 20 minutes to 17 hours, preferably 30 min to 4 hours. In FIG. 2E, the now-exposed surface of the cured layer, 40, is chemically etched to roughen it, and thin layer of electroless copper is applied to the surface. A photoresist layer is applied to the surface, and the photoresist is subject to imagewise irradiation. the image so imposed is developed by ordinary means in common use in the art. Additional copper is then deposited on the exposed electroless copper surface typically via electrolytic methods. The residual photoresist is then removed, and the excess electrolessly deposited copper chemically etched away to leave behind a pattern of in-plane, 32, and through-plane, 34 conductive pathways. The process may be repeated, in principle without limit, and on both sides of the core material, to build up a multilayer printed circuit board.

The above illustrated embodiment is not meant to be limiting. There are other designs of printed circuit boards and a number of fabrication processes known to those skilled in the art, such as those described in M. W. Jawitz “Printed Circuit Board Materials Handbook”, McGraw-Hill (1997), Clyde Coombs, Jr., “Printed Circuits Handbook”, 5th edition, McGraw-Hill Professional (2001), and IPC/JPCA—2315 Standard “Design Guide for High Density Interconnects and Microvias”

In another method of building multiplayer circuits for which the compositions disclosed herein are well suited, the dielectric is coated on copper foil to form a copper clad typically known as resin coated foil (RCF), and laminated to a core such as structure 1 in FIG. 2. Such a process is described in Chapter 11, Coombs (2001), op.cit. The structure is then subjected to further conductor patterning processes.

According to the present invention, a resin coated foil is prepared by coating a metallic, preferably copper, foil with the uncured composition of the invention. In one embodiment, the uncured composition is metered onto a moving copper foil using a combination of coating and compression rolls in a continuous process. Other suitable coating processes are blade or knife coating, slot or extrusion coating, gravure coating, slide coating, curtain coating and the like. The coated foil is then dried, typically in an oven, to increase the viscosity of the uncured coating, partially curing it to form the so-called B-stage composition. In the continuous process, the foil coated with the B-stage composition can be wound on a roll for further use. In some embodiments, a first coating layer is fully cured, and then the coated foil is further coated with one or more additional layers.

In an alternative embodiment, the B-stage laminate is fully cured by itself, following which steps 5-7 in the description above can be carried out to form a single layer printed circuit board. Upon removal of the release sheet, if desired, the same steps can be performed to form a single-layer, two sided printed circuit board. The printed circuit board can serve as the core layer of a multi-layer printed circuit board as described above, or, it can remain a single layer printed circuit board. In a preferred embodiment, the composition further comprises reinforcing fibers such as, for example, carbon, silica, aramid, or glass.

Whether in a single layer or as part of a multi-layer structure, the cured layer can be bored with a drill, a laser or the like to form via holes or through-holes.

The conductive metal layer can be formed by dry plating or wet plating, or by laminating to a metal foil and etching away unneeded regions. Dry plating methods known in the art include sputtering or ion plating. In wet plating, the surface of the cured layer is first roughened with an oxidizing agent such as a permanganate, a bichromate, ozone, hydrogen peroxide/sulfuric acid or nitric acid to form an uneven surface (“anchor”) for anchoring the conductive layer. Then, the conductor may be formed by a method which is a combination of electroless plating and electroplating.

### EXAMPLES

### Thermomechanical Properties Test Method

The coefficient of thermal expansion (CTE) of the test samples was determined using a Thermal Mechanical Analyzer. The IPC-TM-650 Number 2.4.24.5 test method Method B was used. The sample in-plane CTE's were measured by determining the change in dimension which accompanied a change in temperature from 50° C. to 150° C. The glass transition temperature, Tg, was also determined from this analysis as per the referenced procedure.

### EXAMPLES

Comparative Examples A through D and Example 1 were prepared according to compositions and conditions shown in Table 1.

DEN431 epoxy novolac resin was sold by Dow Chemical Company, Midland, Mich. Epoxide equivalent weight was reported as 172-179. NC3000 biphenyl epoxy was sold by Nippon Kayaku Company, Japan. Epoxide equivalent weight was reported as 278. O-cresol novolac epoxy was purchased from Aldrich company (Product no. 408042, CAS 29690-82-2) epoxide equivalent weight was reported as 225. PMDA refers to pyromellitic dianhydride, CAS 89-32-7, Aldrich product 412287. EMI-24 refers to 2-ethyl-4-methyl imidazole, CAS 931-36-2, Aldrich product E36652. DMF was reagent grade dimethylformamide.

The pressure indication on the vacuum oven was measured as gauge pressure where atmospheric pressure (101 kPa) was zero.

TABLE 1
Compositions and processing conditions of examples

| | Comparative | Comparative | Comparative | Comparative | |
|---|---|---|---|---|---|
| Reagents (weight, g) | Example A | Example B | Example C | Example D | Example 1 |
| DEN431 novolac epoxy, g | 3.65 | 6.00 | — | — | — |
| NC3000 biphenyl epoxy, g | — | — | 7.10 | — | — |
| O-cresol novolac epoxy, g | — | — | | 3.50 | 5.00 |
| PMDA, g | 1.35 | 4.00 | 2.90 | 1.50 | 5.00 |
| EMI-24, g | 0.025 | 0.05 | 0.05 | 0.025 | 0.05 |
| DMF, g | 4.0 | 30 | 14 | 16 | 30 |
| Casting gate setting, mm | 0.33 | 0.36 | 0.46 | 0.51 | 0.51 |
| Ambient drying conditions | 30 min | 1 hr | 30 min | 30 min | 30 min |
| Oven drying conditions | 65° C./−17 kPa/1 hr | 65° C./−34 kPa/1 hr | 50° C./−17 kPa/17 hr | 65° C./−17 kPa/1 hr | 50° C./−17 kPa/67 hr |
| (temperature/vacuum/time) | | | | | |
| Curing conditions | 80° C./−17 kPa/0.5 hr | 95° C./−34 kPa/0.5 hr | 100° C./−17 kPa/0.5 hr | 150° C./none/0.5 hr | 100° C./−85 kPa/17 hr |
| (temperature/vacuum/time) | 150° C./none/0.5 hr | 150° C./none/0.5 hr | 150° C./none/0.5 hr | 190° C./none/1.5 hr | 150° C./−17 kPa/0.5 hr |
| | 190° C./none/2.75 hr | 190° C./none/17 hr | 190° C./none/2.75 hr. | | 190° C./none/17 hr |

In each example, the amount of epoxy stated was first dissolved in DMF solvent in a glass bottle. The solution was heated to about 30-40° C. to facilitate the dissolution. PMDA was then added to the solution. Once dissolution was complete, the indicated amount of EMI-24 catalyst solution was added. About 0.5 g of the total DMF weight as shown in Table 1 was reserved for pre-dissolving the EMI-24 catalyst. The catalyst solution was then added to the epoxy solution.

The thus resulting solution was then cast into a film on a polyester film substrate using a doctor blade with the casting gate setting indicated in Table 1. The film was then allowed to dry at room temperature under a nitrogen purge for the time indicated in Table 1, followed by further drying at elevated temperature under vacuum, again as indicated. The thus dried film was removed from the oven, separated from the polyester film backing, and placed on Teflon® PFA release film (sold by DuPont Company). Curing of the film was then completed in a vacuum oven per conditions in Table 1 under “Curing conditions”. The film was then cut into strips for thermal mechanical testing.

The thermomechanical properties of the films are shown in Table 2.

TABLE 2
Thermomechanical Properties

| | | | Wt | Mole | | |
|---|---|---|---|---|---|---|
| | | Curing | epoxy/curing | anhydride/ | CTE, | |
| | Epoxy | agent | agent | epoxy | ppm/° C. | Tg, ° C. |
| Comp. Example A | DEN431 novolac | PMDA | 73/27 | 0.6 | 90 | 186 |
| Comp. Example B | DEN431 novolac | PMDA | 60/40 | 1.1 | 65 | 236 |
| Comp. Example C | NC 3000 epoxy | PMDA | 71/29 | 1.0 | 71 | 210 |
| Comp. Example D | O-cresol novolac | PMDA | 70/30 | 0.9 | 76 | 215 |
| Example 1 | O-cresol novolac | PMDA | 50/50 | 2.1 | 44 | 237 |

### Example 2

The procedures of Example 1 were repeated utilizing the same materials in the same quantities. However, the solution-cast film was dried at 65° C. at −17 kPa for 1 hr, separated from the polyester film backing, and then cured at 90° C. at −85 kPa for 0.5 hr, then 150° C. at atmospheric pressure for 0.5 hr, then 190° C. at atmospheric pressure for 17 hrs.

The cured film was found to have a coefficient of thermal expansion of 51 ppm/° C. over a temperature range of 40 to 198° C., and a glass transition temperature of 238° C.

I claim:

1. A composition comprising 45 to 65 parts by weight of an aromatic or cycloaliphatic dianhydride, and 55 to 35 parts by weight of an aromatic epoxy, or the cross-linked reaction product of 45 to 65 parts by weight of an aromatic or cycloaliphatic dianhydride and 55 to 35 parts by weight of an aromatic epoxy, wherein the molar ratio of anhydride to epoxide units is in the range of 0.4 to 3.0.

2. The composition of claim 1, wherein the composition comprises 45 to 55 parts by weight of pyromellitic dianhydride and 55 to 45 parts by weight of o-cresol novolac.

3. A film or sheet comprising a composition comprising 45 to 65 parts by weight of an aromatic or cycloaliphatic dianhydride, and 55 to 35 parts by weight of an aromatic epoxy, or the cross-linked reaction product of 45 to 65 parts by weight of an aromatic or cycloaliphatic dianhydride and 55 to 35 parts by weight of an aromatic epoxy, wherein the molar ratio of anhydride to epoxy groups is in the range of 0.5 to 3.0.

4. The film or sheet of claim 3, wherein the composition comprises 45 to 55 parts by weight of pyromellitic dianhydride and 55 to 45 parts by weight of o-cresol novolac.

5. A laminated structure comprising a film or layer having a surface, said film or layer comprising the cross-linked reaction product of an epoxy and an aromatic or cycloaliphatic dianhydride, said reaction product comprising 45 to 65 parts by weight of cross-linked aromatic or cycloaliphatic dianhydride residues, and 55 to 35 parts by weight of epoxy residue cross-links, and a plurality of discrete conductive pathways disposed upon said surface.

6. The laminated structure of claim 5, wherein said cross-linked reaction product comprises 45 to 55 parts by weight of cross-linked residues of pyromellitic dianhydride, and 55 to 45 parts by weight of cross linked residues of o-cresol novolac epoxy, and said plurality of discrete conductive pathways disposed upon said surface comprise copper.
